(19) United States
(12) Patent Application Publication
(10) Pub. No.: US 2016/0008213 A1
(43) Pub. Date: Jan. 14, 2016

(54) MASSAGE BAR

(71) Applicant: CHENG-KUO CHENG, TAINAN CITY (TW)

(72) Inventor: CHENG-KUO CHENG, TAINAN CITY (TW)

(21) Appl. No.: 14/325,542

(22) Filed: Jul. 8, 2014

(51) Int. Cl. A61H 15/00

(52) U.S. Cl. CPC A61H 15/0092

(57) ABSTRACT

A massage bar includes a shaft and two handles are connected to two ends of the shaft. A massage roller is mounted to the shaft and includes multiple massage disks of different diameters. Each massage disk has a hole defined centrally therethrough and the shaft extends through the holes of the massage disks. Each massage disk has a massage portion formed on the outside thereof. The massage disks are replaceable to arrange the massage disks to have desired shape to provide desired massage features.

### BACKGROUND OF THE INVENTION

1. Fields of the Invention

The present invention relates to a massage bar, and more particularly, to a massage bar with replaceable massage disks to provide desirable massage features.

2. Descriptions of Related Art

The conventional way of massage generally use hands to press and/or rub the muscles to increase the blood circulation. The massage therapy becomes one of important and effective ways to provide relief of stress and help with health condition. The long term of massage is deemed to help the body to maintain better condition and is also healthy to interior of our bodies. There are different styles and techniques of massage available, usually, the use of a combination of hands and tools are preferable.

However, the massage tools such as a massage bar has a fixed shape and it can only provide limited features. The fixed shape of the massage bar is not suitable for providing desired massage features to different portions of the body.

The present invention intends to provide a massage bar with replaceable massage disks so as to eliminate the shortcomings mentioned above.

### SUMMARY OF THE INVENTION

The present invention relates to a massage bar and comprises a shaft and two handles are connected to two ends of the shaft. A massage roller is mounted to the shaft and the massage roller comprises multiple massage disks of different diameters. Each massage disk has a hole defined centrally therethrough, and the shaft extends through the holes of the massage disks. Each massage disk has a massage portion formed on the outside thereof.

Preferably, each of the massage disks has plural apertures defined therethrough so that the massage portions are flexible by squeezing the apertures.

Preferably, the shaft has positioning grooves defined in each of the two ends thereof. Each handle has ridges on the inside thereof. The ridges are engaged with the positioning grooves.

Preferably, the shaft is made of a flexible material.

The primary object of the present invention is to provide a massage bar that the massage disks are replaceable and have different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the massage bar of the present invention;

FIG. 2 is a perspective view to show the massage bar of the present invention;

FIG. 3 is a cross sectional view of the massage bar of the present invention;

FIG. 4 is a perspective view to show another embodiment of the massage bar of the present invention;

FIG. 5 is a cross sectional view of the massage bar of the present invention disclosed in FIG. 4;

FIG. 6 shows that the shaft of the massage bar of the present invention is bent, and

FIG. 7 shows the use of the massage bar of the present invention wherein the shaft is bent.

### DETAILED DESCRIPTION OF THE PREFERRED EMBODIMENT

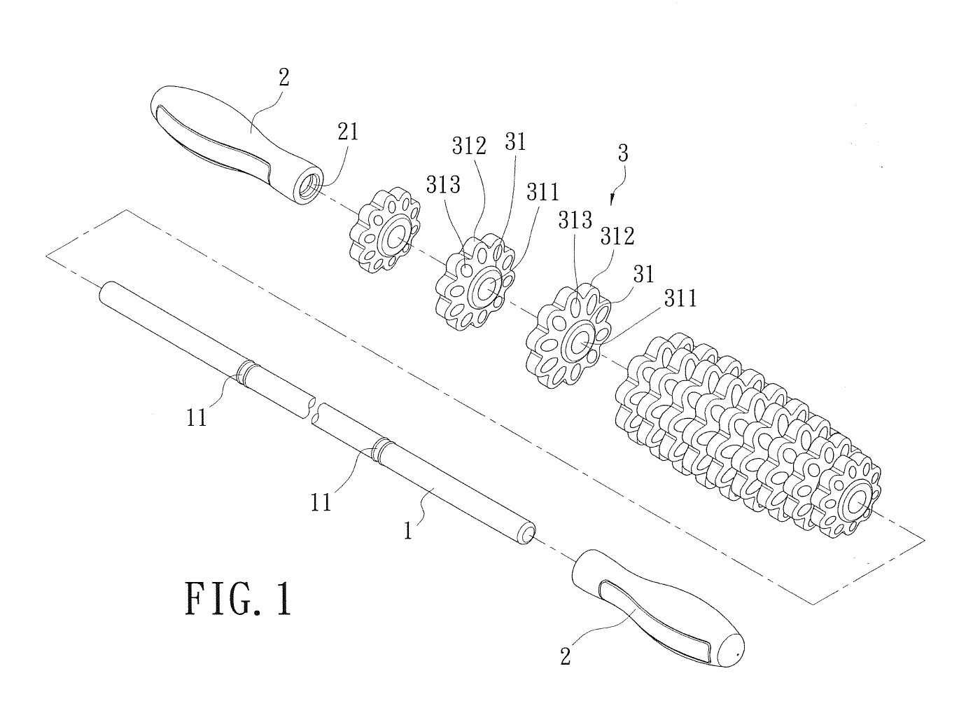

Referring to FIGS. 1 to 3, the massage bar of the present invention comprises a shaft 1, two handles, 2 and a massage roller 3. The shaft 1 has positioning grooves 11 defined in each of the two ends thereof. Each handle 2 has ridges 21 on an inside thereof. The ridges 21 are engaged with the positioning grooves 11 to connect the handles 2 to the shaft 1.

The massage roller 3 is mounted to the shaft 1 and comprises multiple massage disks 31 of different diameters. Each massage disk 31 has a hole 311 defined centrally therethrough, and the shaft 1 extends through the holes 311 of the massage disks 31. Each massage disk 31 has a massage portion 312 in a zigzag shape, defined by plural protrusions and recesses, on the outside thereof. Each of the massage disks 31 has plural apertures 313 defined therethrough, and each aperture 313 is formed between every two recesses of the massage portion 312 to allow the massage portions 312 to become flexible by squeezing the apertures 313.

The user holds the two handles 2 and moves the massage bar along the portions to be massaged. The massage disks 31 are rotatably positioned between the two handles 2 and the massage portions 312 of the massage disks 31 roll to provide the massage features. It is noted that because of the apertures 313, the massage portions 312 are flexible and provide comfortable massage features.

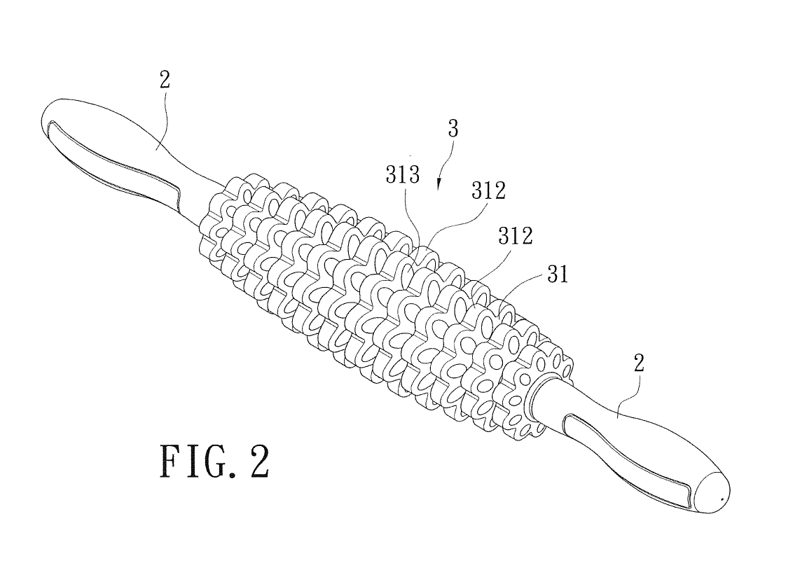

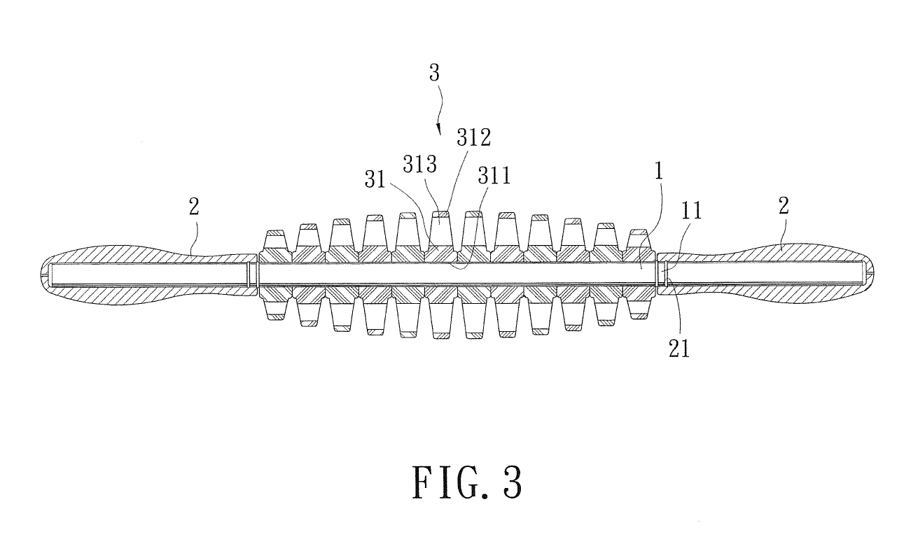

The massage disks 31 are replaceable, so that the user can arrange the massage disks 31 of different diameters to form a specific curvatures to meet the need of massage. As shown in FIGS. 2 and 3, the massage disks 31 form a spindle-like shape with a wider mediate portion.

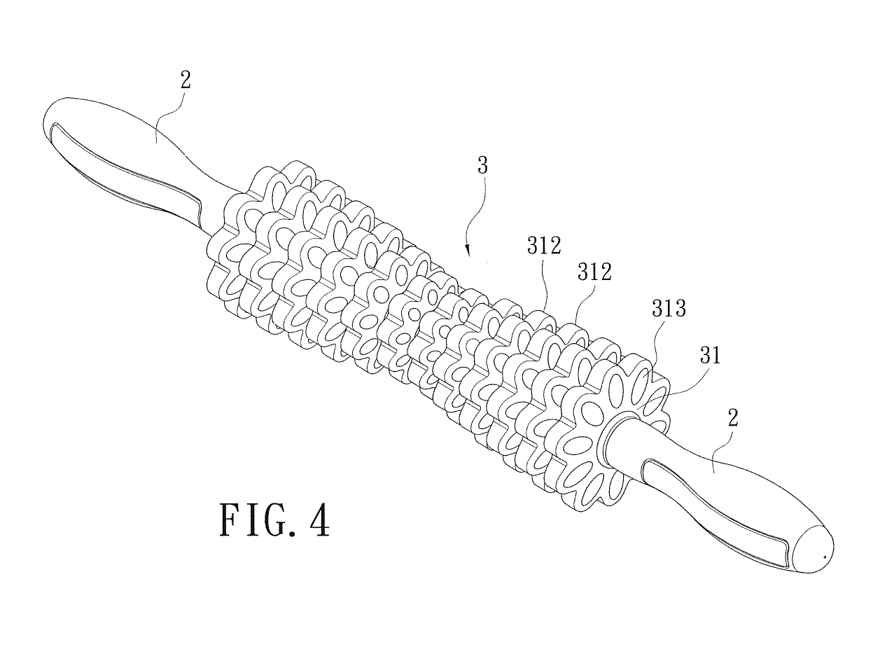

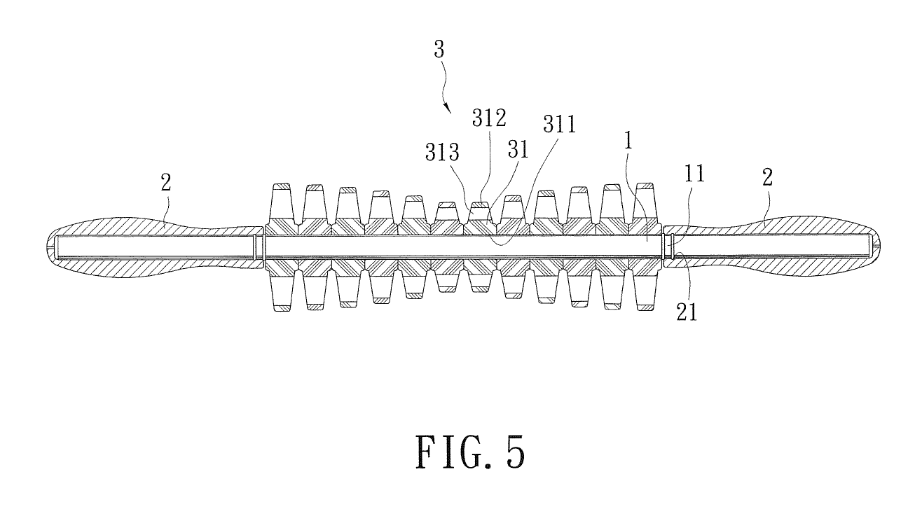

FIGS. 4 and 5 show another embodiment of the massage bar of the present invention, the massage disks 31 are re-arranged to form an hourglass-shaped massage roller 3. The hourglass-shaped massage roller 3 meets a specific shape of the body portion.

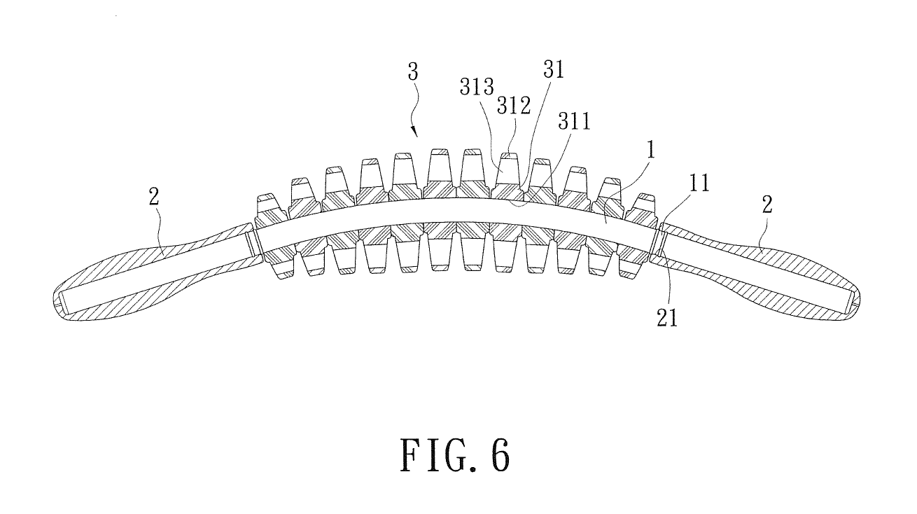

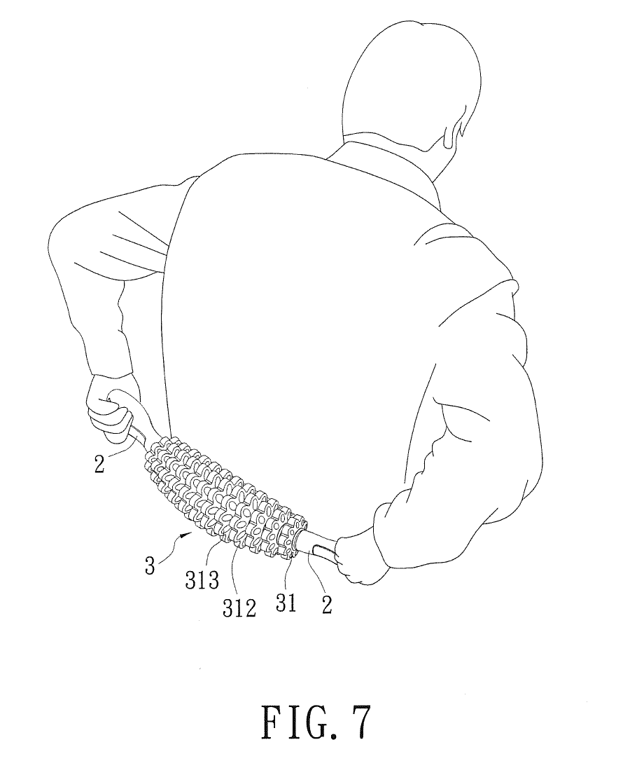

As shown in FIGS. 6 and 7, the shaft 1 is made by a flexible material and the massage disks 31 are mounted to the shaft 1 as the previous embodiment. When users hold the two handles 2 and rolls the massage disks 31 along the body, such as the user's back, the shaft 1 is properly bent and deformed to allow the massage disks 31 to be more matched with the curvature of the body to enhance the massage features.

The massage bar of the present invention allows the user to replace and/or re-arrange the massage disks 31 to have a desired shape to meet different requirements when massaging different portions of the body.

While we have shown and described the embodiment in accordance with the present invention, it should be clear to those skilled in the art that further embodiments may be made without departing from the scope of the present invention.

What is claimed is:

1. A massage bar comprising:
a shaft;
two handles connected to two ends of the shaft, and
a massage roller mounted to the shaft and the massage roller having multiple massage disks of different diameters, each massage disk having a hole defined centrally therethrough, the shaft extending through the holes of the massage disks, each massage disk having a massage portion in a zigzag shape defined by plural protrusions and recesses on an outside thereof.

2. The massage bar as claimed in claim 1, wherein each of the massage disks has apertures defined therethrough, the massage portions are flexible by squeezing the apertures.

3. The massage bar as claimed in claim 1, wherein the shaft has positioning grooves defined in each of the two ends thereof, each handle has ridges on an inside thereof, the ridges are engaged with the positioning grooves.

4. The massage bar as claimed in claim 1, wherein the shaft is made of a flexible material.
